(19) United States
(12) Patent Application Publication
(10) Pub. No.: US 2010/0032944 A1
(43) Pub. Date: Feb. 11, 2010

(54) Optimized Stub-Out

(76) Inventor: Richard Anderson, Iron Mountain, MI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/187,137

(22) Filed: Aug. 6, 2008

(51) Int. Cl. F16L 41/16

(52) U.S. Cl. 285/189

(57) ABSTRACT

An optimized stub-out, sizing system, and method of manufacture for an optimized stub-out having a length adapted to the type of fixture or appurtenance being installed and having a flat-end adapted to piercing.

### FIELD OF THE INVENTION

This invention relates generally to the field of plumbing, and in particular to a stub-out optimized for piercing and efficient use of materials.

### BACKGROUND

The current practice in the construction of a new dwelling is to “rough-in” the waste and water supply lines where the new fixtures or appurtenances are to be located utilizing a stub-out pipe which protrudes from the wall or floor. A stub-out pipe is a short length of pipe installed during construction, which is connected to the main plumbing pipes. Fixtures or appurtenances are eventually installed and connected to the stub-out.

Currently, water line stub-outs typically consist of commercially available preformed pieces of copper pipe with a sealed, rounded end that protrudes from the wall or floor. Generally, plumbing systems must be pressure tested before fixtures or appurtenances are installed. Once the plumbing system has been pressure tested, it is common practice to leave the water supply turned on, with water remaining in the lines.

In the past, plumbing rough-ins were accomplished by cutting the copper tubing used for the water lines and applying an end cap to the cut pipe, which would then serve as a stub-out. The current practice in the plumbing industry for plumbing rough-ins is to use copper and/or plastic tubing of various compositions to which a copper (or other type of metal or material) stub-out is attached.

When the plumber subsequently installs the new fixtures or appurtenances, it is presently required that the water supply be turned off and the water in the lines drained. The plumber must locate the water supply shut-off valve, turn off the water supply, and then drain the water from the system. The plumber then returns to the location of the fixture or appurtenance and uses a tube-cutting tool to cut off the sealed end of the stub-out. After the sealed end is removed, the plumber installs a commercially available angle stop device. An angle stop is a device which connects the water supply pipe in the wall or floor to the faucet, toilet, or other plumbing fixture or appurtenance and allows the water flowing to the fixture or appurtenance to be turned on and off. After installing the standard angle stop, the plumber then returns to the water supply shut-off valve and turns the water supply back on. At this point, there will likely be air remaining in the system, which can cause problems with any previously installed and functioning fixtures or appurtenances.

After restoring the water supply, the plumber then returns to the fixture or appurtenance, connects the supply line to the fixture or appurtenance and opens the angle stop supplying water to the fixture or appurtenance.

Attempts have been made in the prior art to make the process of using a stub-out and angle stop more efficient by piercing a soldered sealing cap of a type formerly used on pipe which served as a stub-out, rather than shutting off the water and cutting the pipe after sealing the stub-out pipe. The device taught in the Colson patent is now obsolete due to the availability of commercially available, standard diameter, pre-sealed stub-outs which do not require installers to solder caps during the installation process.

The portion of a stub-out which protrudes from a wall or floor after installation (to which a fixture or appurtenance is connected) is currently manufactured in standard lengths of approximately 6-12 inches. These lengths do not correlate to the type of fixtures or appurtenances being installed which require varying stub-out lengths. Presently, the portion that protrudes from the wall or floor must be cut, resulting in a substantial amount of wasted copper (or other metal or materials from which a stub-out is made). However, it has not been practical in the prior art to manufacture stub-outs with a shorter protruding portion because the required finished (cut) length of the protruding portion varies depending on the type of fixture or appurtenance being installed (e.g., a sink, toilet, or urinal). Each type of fixture or appurtenance requires that the protruding portion have a different finished length, and current stub-out designs contemplate that the plumber or installer will cut the protruding portion appropriately and discard the excess copper.

An additional problem with conventional stub-outs currently exists regarding the shape of the sealed end of the stub-out which is ultimately attached to the angle stop and then to the fixture or appurtenance. Although it may be more advantageous to pierce rather than cut the sealed end of the stub-out when connecting the water supply to the angle stop and subsequently to the fixture or appurtenance, the generally rounded or pointed shape of the sealed ends of the stub-out, as known in the prior art, presents several problems relative to piercing and adapting a tool for piercing.

Although the diameter of the pipe portion of the stub-out which protrudes from the wall or floor is based on industry standards (and thus has a uniform diameter), the sealed end portion of a stub-out can have various non-uniform shapes and contours. Thus, it is difficult to design a tool to pierce the sealed end portion of the stub-out, since stub-out can have various rounded shapes.

It is desirable to create an optimized stub-out apparatus especially adapted for piercing for use with such a system.

It is further desirable to design a stub-out which minimizes the copper waste that occurs when presently available stub-outs are cut to accommodate various types of fixtures or appurtenances.

### Glossary

As used herein, the term “stub-out” shall refer to any element or system that is a preformed pipe with an open connecting end and a sealed end which is installed during the construction of a plumbing system before fixtures or appurtenances are installed. The sealed end of the stub-out protrudes from the wall or floor, and the open end of the stub-out is connected to the pipes of the main plumbing system using fitting adaptation features. Generally, a stub-out is constructed from copper or other metal alloy, but may be constructed from any suitable alternate material or composite.

As used herein, the term “fitting adaptation” means a manufactured feature on the open-end of a stub-out which facilitates connection of the stub-out to the pipes of the main plumbing system. Exemplary fitting adaptations include contouring, curvature, indentations, protrusions, a quick-connect end, barbed end, a male or female solder end, a compression end, CPVC end, threaded end, swivel end, pex end or any other component, device or feature which is used to connect a stub-out to copper, plastic or other types of piping.

As used herein, the term “piercing point” shall refer to a permanently or removably affixed component which is used to pierce the surface of the protruding portion of a stub-out. A piercing point may include a point made of stainless steel, steel, brass, nickel, metal alloy, or ceramic. A piercing point may be serrated including one or more serrations, and may be mechanized to enhance piercing capability.

As used herein, the term “partially flattened” or “flat-end” refers to a shape or contour that is partially or substantially flattened or compressed (e.g., not rounded or pointed).

As used herein, the term “protrusion” or “protruding portion” refers to the portion of a water line stub-out which is substantially exposed through the inside walls or floors of a home or building and which connects to a fixture or appurtenance. For a curved stub-out, the protrusion is measured from the center of the elbow or curved section to the sealed end of the stub-out. A straight stub-out is measured from the open end of the stub-out to the sealed end of the stub-out.

As used herein, the term “toilet length” refers to a stub-out having a measurement of approximately 2.0 to 4.5 inches measured from the center of the elbow or curved section to the sealed end of the stub-out for a curved stub-out. For a straight stub-out, toilet length is a stub-out having a length of 3 to 5.5 inches measured from the open end to the sealed end of the stub-out.

As used herein, the term “sink length” refers to a stub-out having a measurement of approximately 4.5 to 6.5 inches measured from the center of the elbow or curved section to the sealed end of the stub-out. For a straight stub-out, sink length is a stub-out having a length of 5.5 to 7.5 inches measured from the open end to the sealed end of the stub-out.

As used herein, the term “extended length” refers to a stub-out having a measurement of approximately 6.5 to 11.75 inches or longer measured from the center of the elbow or curved section to the sealed end of the stub-out. For a straight stub-out, extended length is a stub-out having a length of 7.5 to 11.75 inches or longer measured from the open end to the sealed end of the stub-out.

As used herein, the term “fixture” refers to any appurtenances, appliance, sink, toilet, urinal, plumbing accessory, equipment, installation, fitting or device known in the plumbing art which may be affixed using an stub-out.

### SUMMARY OF THE INVENTION

The present invention is a specially contoured (flattened or partially flattened) optimized stub-out specifically adapted for piercing and is manufactured in specially calculated sizes to correlate with particular devices installed using the stub-out.

### BRIEF DESCRIPTION OF THE DRAWINGS

FIG. 1 shows an exemplary embodiment of an optimized stub-out which is curved.

FIG. 2 shows one embodiment of an optimized stub-out which is straight.

FIG. 3 shows an exemplary embodiment of a curved optimized stub-out which includes a flange.

FIG. 4 shows an exploded view of one embodiment of the piercing valve stem assembly system using an optimized stub-out.

FIG. 5 shows a sectional side view of one exemplary embodiment of the piercing valve stem assembly system with a partially flattened optimized stub-out.

### DETAILED DESCRIPTION OF THE INVENTION

For the purpose of promoting an understanding of the present invention, references are made in the text hereof to embodiments of an angle stop valve, only some of which are described herein. It should nevertheless be understood that no limitations on the scope of the invention are thereby intended. One of ordinary skill in the art will readily appreciate that there may be modifications, such as the dimensions of the piercing valve stem assembly. Alternate, but functionally similar material(s) may be used. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily drawn to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related.

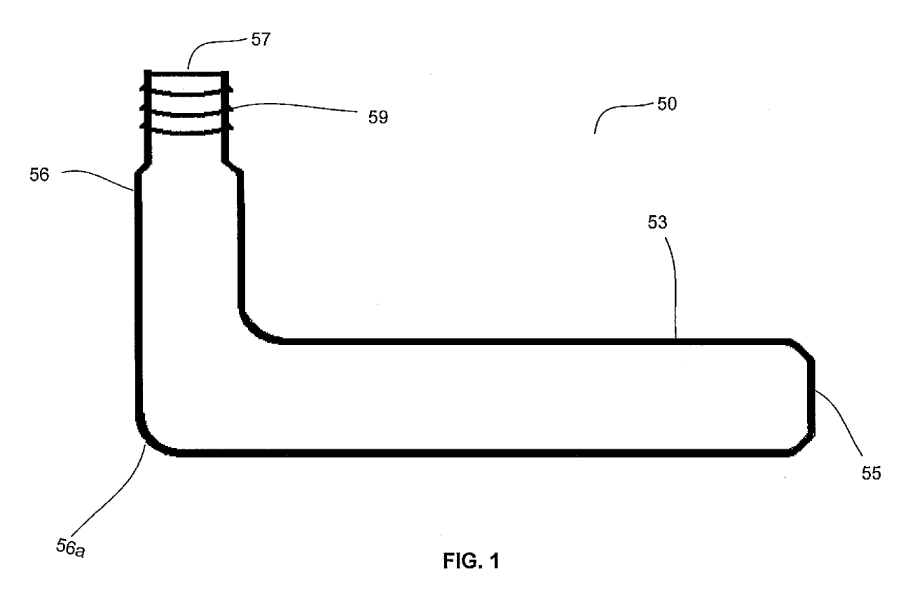

Referring now to the drawings, FIG. 1 shows an exemplary embodiment of optimized stub-out 50, which is curved, including protruding portion 53, flat-end 55 (which is sealed), open-end 57, concealed portion 56 and optional fitting adaptations 59. In the embodiment shown, optimized stub-out 50 is curved at an approximate 90-degree angle from concealed portion 56 at elbow 56a. In the embodiment shown, concealed portion 56 is approximately 3.25 inches, measured from the open-end 57 to the center portion of the elbow 56a. After optimized stub-out 50 has been installed, the concealed portion 56 is concealed behind a fixed building structure such as a wall or floor. In the embodiment shown, protruding portion 53 is manufactured in three specialized lengths (toilet length, sink length and extended length) correlated to specific categories of fixtures or appurtenances (each of which vary from the standardized eight inch length found in the prior art).

The embodiment shown in FIG. 1 depicts a toilet length optimized stub-out 50 having a length of approximately 2 to 4.5 inches measured from the center of the elbow 56a or curved section to flat-end 55 of optimized stub-out 50. Alternative curved embodiments may be sink length having a protruding portion 53 of approximately 4.5 to 6.5 inches measured from the center of elbow 56a or curved section to the sealed end of optimized stub-out 50, or an extended length of approximately 6.5 to 11.75 inches or longer measured from the center of elbow 56a or curved section to the sealed end of optimized stub-out 50.

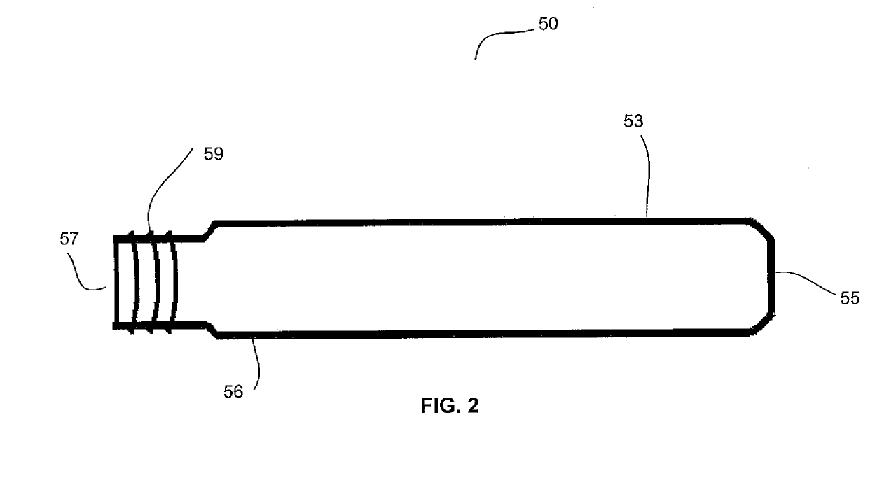

FIG. 2 illustrates a further embodiment of optimized stub-out 50, which is straight. Illustrated in FIG. 2 are flat-end 55, open-end 57, concealed portion 56, protruding portion 53 and optional fitting adaptations 59. After optimized stub-out 50 has been installed, concealed portion 56 is concealed behind a fixed building structure such as a wall or floor. In the embodiment shown, protruding portion 53 is manufactured in three specialized lengths (toilet length, sink length and extended length) correlated to specific categories of fixtures or appurtenances (each of which vary from the eight inch length found in the prior art).

The embodiment shown in FIG. 2 depicts an embodiment of optimized stub-out 50 which is s straight, toilet length stub-out with a length of approximately 3 to 5.5 inches measured from open-end 57 to the sealed end of optimized stub-out 50. Alternative embodiments may be sink length approximately 5.5 to 7.5 inches measured from open-end 57 to the sealed end of stub-out 50, or extended length of approximately 7.5 to 11.75 inches or longer.

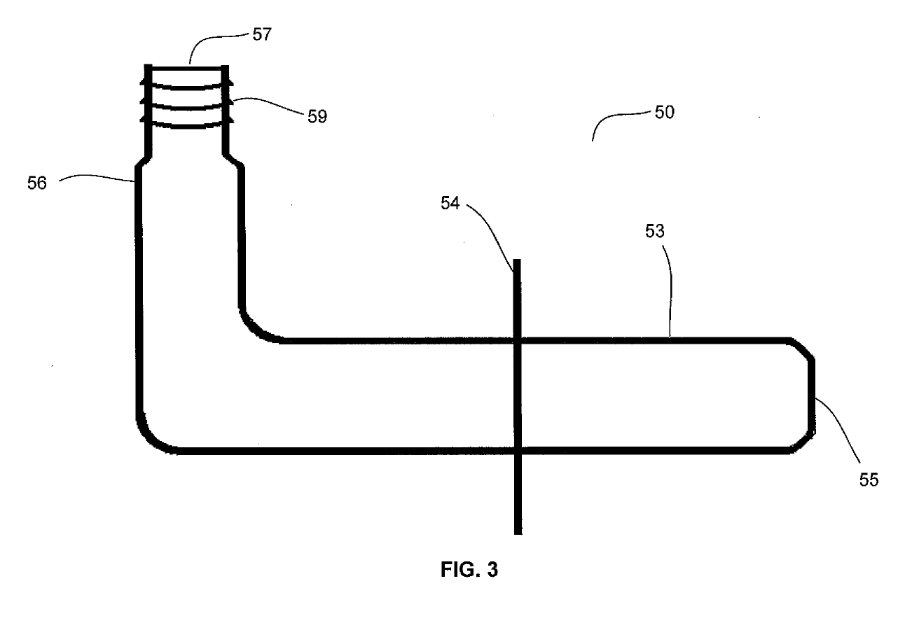

FIG. 3 depicts an embodiment of optimized stub-out 50 which is curved, further showing a flange 54 which may be attached to either a straight or curved stub-out 50 for mounting the stub-out 50 to a wall or floor. Flange 54 may be attached, detached, permanently or temporarily affixed. In various embodiments flange 54, may be made of copper or other suitable metals or materials.

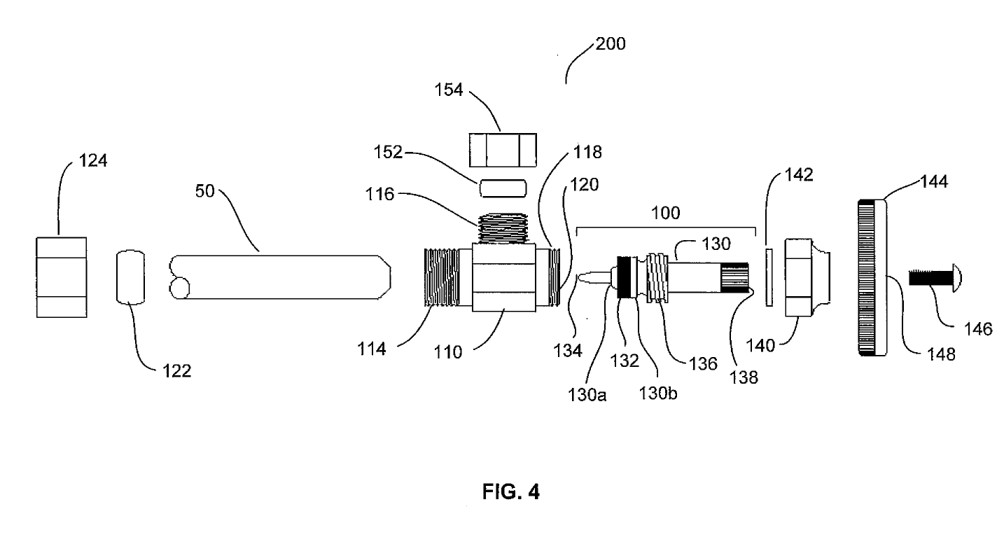

FIG. 4 is an exploded view of piercing valve stem assembly 200 in which a straight embodiment of optimized stub-out 50 is used.

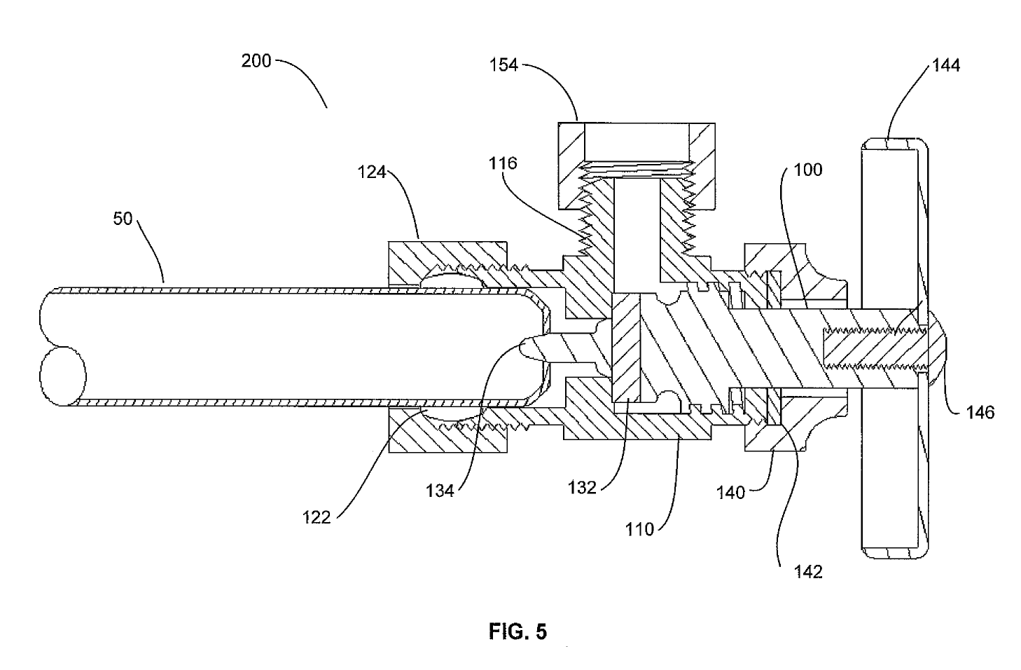

FIG. 5 shows a sectional side view of one exemplary embodiment of piercing valve stem assembly 200 in which optimized stub-out 50 is used.

1. An optimized stub-out comprised of:
a stub-out body having a sealed substantially flat-end created by pressure applied during the manufacturing process; and
an open-end adapted for connection to a piece of pipe.

2. The optimized stub-out of claim 1, wherein said optimized stub-out has a length selected from a group consisting of toilet length, sink length and extended length.

3. The optimized stub-out of claim 1, wherein said optimized stub-out is manufactured from a material that is suitable for potable water.

4. The optimized stub-out of claim 1, wherein said open-end is adapted for connection using a means selected from a group consisting of a of a pipe, a soldered pipe end and a compression device used to attach two pieces of pipe.

5. The optimized stub-out of claim 1, wherein said flat-end is a surface adapted to be pierced with a piercing tool.

6. The optimized stub-out of claim 1, wherein said stub-out body is curved.

7. The optimized stub-out of claim 1, wherein said stub-out body is straight.

8. The optimized stub-out of claim 1, wherein said stub-out further comprises a flange.

9. An optimized stub-out comprised of a stub-out body having:
an open-end;
a concealed portion;
a sealed substantially flat-end; and
a protruding portion located along a stub-out body having a predetermined length based on the type of fixture installed.

10. The optimized stub-out of claim 9, wherein said fixture is selected from a group of categories consisting of toilet length, sink length and extended length, each of which is correlated to the appropriate stub-out size.

11. The optimized stub-out of claim 9, wherein said flat-end is a surface adapted to for piercing with a piercing tool.

12. The optimized stub-out of claim 9, wherein said stub-out body is curved.

13. The optimized stub-out of claim 9, wherein said stub-out out body is straight.

14. The optimized stub-out of claim 9, wherein said stub-out further comprises a flange.

15. A system of minimizing waste material in using a stub-out by manufacturing stub-outs in predetermined lengths based on categories of fixtures.

16. The system of claim 15, wherein said categories of fixtures are determined by analyzing the optimum stub-out length for fixtures listed within each of said categories of fixtures.

17. A system comprised of:
an optimized stub-out having a flat-end adapted for piercing; and
an angle stop adapted for piercing a stub-out having a flat-end.

18. The system of claim 17 wherein said optimized stub-out is manufactured by a method selected from a group consisting of molding, spinning, machining and extruding.

19. A method of manufacturing a flat-end stub comprised of:
extruding copper to create a pipe; and
applying pressure during the extrusion process to create a substantially flattened end.

20. The method of manufacture of claim 19 which further comprises conforming the length of said flat-end stub-out to conform to a predetermined category based on a grouping of fixtures correlated with an optimum stub-out length.
